(19) United States
(12) Patent Application Publication
(10) Pub. No.: US 2014/0134426 A1
(43) Pub. Date: May 15, 2014

(54) NANO-BASED SELF-HEALING ANTI-CORROSION COATING

(71) Applicant: James Jackson Milham Henry, Houston, TX (US)

(72) Inventor: James Jackson Milham Henry, Houston, TX (US)

(73) Assignee: ROK Investment Group Limited, Albrighton, West Midlands (GB)

(21) Appl. No.: 14/128,606

(22) PCT Filed: Jun. 25, 2012
(86) PCT No.: PCT/US12/44067

§ 371 Date: Dec. 21, 2013

Related U.S. Application Data
(60) Provisional application No. 61/500,541, filed on Jun. 23, 2011.

(51) Int. Cl. C23F 11/173; B05D 7/14

(52) U.S. Cl. CPC C23F 11/173; B05D 7/14
USPC 428/327; 427/406; 427/409; 428/328; 428/423.3; 252/389.23

(57) ABSTRACT

The present invention is directed to a synergistic multilayer anti-corrosion resistant coating for a metal surface, the coating having three subcoatings, a) a self assembled monolayer nanoprimer; b) a polymeric primer; c) a polymeric top coat containing microcapsules for self-healing. The present invention is further direction to systems and methods for producing the coating in situ on the metal surface. The present invention provides an economical, non-epoxy-based, corrosion coating having favorable resistance to acid and to salt water, and having favorable adhesion properties.

### CROSS-REFERENCE TO RELATED APPLICATIONS

This application for patent claims priority to U.S. Provisional Patent Application Ser. No. 61/500,541, filed Jun. 23, 2011.

### FIELD OF THE INVENTION

The present invention relates generally to anti-corrosion coatings, systems, and methods, and specifically to self-healing coatings incorporating a nanoscale primer.

### BACKGROUND OF THE INVENTION

Corrosion resistant coatings are useful for protecting metal structures from degradation, particularly environmentally mediated degradation, such as from oxidation. Rust of iron and carbon steel are common examples of corrosion. Corrosion resistant coatings are desirable in a number of particular applications.

Corrosion resistant coatings are useful for bridges. Operation of the coating under temperature induced expansion and contraction is desirable. Conventionally bridges are coated with a three part coating having an epoxy intermediate layer between a zinc-rich primer and a polyurethane. The zinc-rich primer may be an orthosilicate, an epoxy, or a polyurethane. The zinc acts as a sacrificial metal, reducing damage from oxidation. The zinc is typically added to the primer as a powder. The polyurethane is a durable topcoat. The epoxy acts as a seal and provides better corrosion resistance than polyurethane. However, epoxy has the disadvantage that it is not flexible and is prone to cracking under expansion and contraction of bridge metal due to temperature changes.

Corrosion resistance coatings are also useful for metal structures in oil refineries. Operation while exposed to corrosive hydrofluoric acid used in oil refining is desirable. However, epoxy-containing coatings are susceptible to degradation from hydrofluoric acid.

Corrosion resistant coatings are also useful for utility pipes and other metal structure disposed in sewer pipes. In this environment, operation while exposed to water is desirable. However, water is an oxidizing environment that hastens corrosion.

Conventionally automobiles receive a layered paint that uses polyurethane over epoxy. Automobiles in cold climates are exposed to road salt that is used to melt snow. Road salt notoriously corrodes automobile metal. In this environment, operation while exposed to salt water is desirable.

Thus, there remains a need for a cost-effective non-epoxy-based corrosion resistant coating operable in environments of temperature swings, strong acid, water, and/or road salt.

### BRIEF DESCRIPTION OF THE INVENTION

The present invention is directed to a synergistic multilayer anti-corrosion resistant coating for a metal surface, the coating having three subcoatings, a) a self assembled monolayer nanoprimer; b) a polymeric primer; c) a polymeric top coat containing microcapsules for self-healing. The subcoatings order outwardly from the metal as nanoprimer/polymeric primer/topcoat. The subcoatings adhere together. Each one of a pair of adjacent subcoatings adheres to the other of the pair. The SAMP nanoprimer provides molecular scale sealing superior to epoxy. The microcapsules render the coating self-healing. Each of the primer and the top coat may be viscoelastic. The viscoelasticity imparts elongation and thus resistance to cracking under thermal cycling. A cleansing coat may be disposed between the substrate and the corrosion resistant coating. The corrosion resistant coating adheres to the substrate or to the cleansing coated substrate. The polymeric primer may contain zinc. The zinc may be in the form of zinc flakes. The zinc flakes combat oxidation of the metal substrate. The topcoat may contain a fixotropic additive. Polymeric primer may be supplied as an A primer component and a B primer component for mixing on site. Similarly, polymeric top coat may be supplied as a an A top coat component and a B top coat component for mixing on site. For each of primer and top coat, the A component may contain resin and the B component may contain curative. According to some embodiments, the top coat polymer is a polyurethane. When the top coat is a polyurethane, the microcapsules may contain an isocyanate, such as a diisocyanate. According to some embodiments, the polymeric primer includes a polyurethane.

In some embodiments, an anti-corrosion coating for a metal surface comprises a nanoprimer comprising a self-assembled phosphonate monolayer disposed over the metal surface; a polyurethane primer disposed over the nanoprimer; a polyurethane top coat disposed over the polyurethane top coat comprising microcapsules adapted for self-healing, wherein the polyurethane top coat adheres to the polymeric primer; and microcapsules adapted for self-healing, wherein the microcapsules are dispersed in the polyurethane top coat. The microcapsules may comprise a diisocyanate core and a paraffin wax shell. The polyurethane primer may comprises a plurality of zinc flakes. The nanoprimer may adheres to the metal surface. The anti-corrosion coating may comprises a cleansing coat. The nanoprimer may adheres to the cleansing coat. The polyurethane top coat may further comprises a fixotropic. The polyurethane top coat may be derived from reaction of a top coat resin component A and a top coat curative component B. The top coat curative component B may comprise a solvent comprising cyclohexanone. The cyclohexanone solvent may promote adherence of the polyurethane top coat to the polyurethane primer.

In some embodiments, an anti-corrosion coating comprises a self-assembled phosphonate monolayer disposed over the metal surface; a polyurethane primer disposed over the nanoprimer; a polyurethane top coat disposed over the polyurethane top coat comprising microcapsules adapted for self-healing, wherein the polyurethane top coat adheres to the polymeric primer; and microcapsules adapted for self-healing, wherein the microcapsules are dispersed in the polyurethane top coat; a cleansing coat disposed over the metal surface and under the nanoprimer; and zinc flakes dispersed in the polyurethane primer, wherein the microcapsules comprise a diisocyanate core and a paraffin wax shell; and wherein the polymeric top coat comprises a fixotropic.

In some embodiments, an anti-corrosion system comprises a cleansing coat solution; a nanoprimer solution comprising phosphonate; a polyurethane primer resin solution; a polyurethane primer curative solution; a polyurethane top coat resin solution; a polyurethane top coat curative solution; and self-healing microcapsules each comprising a diisocyanate core and a paraffin wax shell. The system may further comprise seven containers, one for each solution. The anti-corrosion system according to claim 12 may further comprise a plurality of zinc flakes. The anti-corrosion system may further comprise a fixotropic solution.

In some embodiments, a method for protective a metal surface, comprises disposing a nanoprimer comprising a self-assembled phosphonate monolayer over the metal surface; disposing a polyurethane primer over the nanoprimer; and disposing a polyurethane top coat over the polyurethane primer, wherein the polyurethane top coat comprises microcapsules adapted for self-healing. The microcapsules may each comprise a diisocyanate core and a paraffin wax shell. Disposing the polyurethane top coat may comprise dispersing a plurality of microcapsules adapted for self-healing in a polyurethane top coat resin; mixing the polyurethane top coat resin with a polyurethane top coat curative; and applying the mixture to the polymeric primer. The polyurethane top coat curative solution may comprise a cyclohexanone solvent. The method may further comprise dispersing zinc flakes in the polyurethane primer.

The present coating is operable to protect a metal surface in environments of one or more of temperature swings, strong acid, water, and/or road salt.

The foregoing has outlined rather broadly the features of the present invention in order that the detailed description of the invention that follows may be better understood. Additional features and advantages of the invention will be described hereinafter which form the subject of the claims of the invention.

### DETAILED DESCRIPTION OF THE INVENTION

The present invention is directed to coatings, systems, and method for protecting metal surfaces from corrosion.

The present inventors believe that there currently exists a need for an nano-scale SAMP Primer anti-corrosion protective coating with self healing properties that does not now embody all of the properties, characteristics, attributes, and benefits of CORTAIN.

According to some embodiments, CORTAIN NANO-PRIMER utilizes a nano-based primer coating that is designed specifically to create a high bond [8000 psi in shear] between both the metal surface and, of equal importance, a nano-chemical symbiosis with the coating primer, that to our knowledge did not exist in its present form before this advent.

A nano-coating employed with CORTAIN is characteristically a “SAMP” as defined by those skilled in the art, as a Self Assembled Monolayer Phosphonate. (See, for example, Journal of the American American Chemical Society article 2004 pg. 5333-5337 by Princeton University; and PCT/US2007/079802, Publication No. WO2008039959, assigned to Aculon.)

See also, article titled Cell Attachment and Spreading Metal Implant Materials, regarding adhesion.

According to some embodiments, CORTAIN NANO-PRIMER utilizes a nano-coating that provides a protection layer that, when sprayed onto the metal surface, will provide a 1 to 2 nano-meter thick layer that penetrates into the smallest microfissures of the metal and prevents 1/2 nano-meter sized hydrogen and oxygen molecules from contacting the metal bearing ferrous oxides while simultaneously bonding with a visco-elastic polurea/polyurethane or other similar type coating. In some embodiments, a first conventional priming layer may be layered under the nano-coating, such as any suitable metal surface preparation compound.

According to some embodiments, SAMPs accomplish this property by simply spraying the nano-coating on a metal surface and allowing it to dry [in about 30 seconds]. The nano particles are “jumbled” together when constituted in the liquid form. Upon drying, the nano-silica particles actually “stand up” or “self align” like soldiers standing at attention. Under an electron microscope at 2500 to 10,000×, one can observe the nano-silica particles form a uniform array.

This array prevents hydrogen and oxygen molecules from contacting the metal surface.

As long as the nano-SAMPs are in place, left undisturbed, in theory, the metal is protected “indefinitely,” according to Sandia Labs.

But, as discussed, nano-coatings do not currently have the durability without some form of a more robust overcoating protection.

The present inventor believes that other nano-coatings currently existing act like “teflon” preventing a useful bond between the metal and the primer coating.

CORTAIN's nano-coating was specifically tested and designed to bond utilizing a “velcro” type adhesion between the nano-coating and the visco-elastic primer that is designed to bond symbiotically on one side to the SAMP nano-coating and also to provide significant adhesion on the other side to the top coat [final coat].

According to some embodiments, CORTAIN POLYMER PRIMER utilizes a two part primer [ONE TO ONE RATIO] coat made up of, on the A side: diphenylmethane diisocyanate of 5 to 10% by volume. Urethane Prepolymer of between 35 to 45% by volume. Tolulene Diisocynate 0.05% by volume. The A side may further comprise toluene. The toluene serves as a solvent. According to some embodiments, the A side is made up of 40-50% urethane prepolymer (e.g. CAS (Chemical Abstract Service) 64771-77-3); 5-10% 4′,4-diphenylmethane diisocyanate; <0.05% toluene diisocyanate; and 40-50% toluene. The B side is made up of MEK of between 65% and 70% by volume. Also, aromatic diamine of between 20 to 30% by volume. The polymer primer may be layered over the nano-primer.

According to some embodiments, CORTAIN TOP COAT, by utilizing the unique combination of urea and urethane components, is resistant to 48% hydrofluoric acid at 140 f, as well as nitric acid at 30%, for 30 days, and many other acids as stated below. The top coat may be layered over the polymer primer.

Comparative testing for urethanes and urea coatings as well as epoxy and ceramic coatings, has seen total failure with ratings tested by EXOVA and POLYHEDRON LABS, as well as INDUSTRIAL POLYMER LABS, for lab exposures, completely dissolving into a gooey gelatinous mass in several days.

CORTAIN will allow petro-chemical firms to utilize CORTAIN in large tank farms that are required by federal and state laws to erect and maintain complete emergency containment facilities without having to use DuPont VITON at ten times the cost for materials.

These acid resistant and nano-primer properties contained within CORTAIN increase life cycle durability and reduce the environmental impact of coating infrastructures by recoating with less frequency over the decades.

According to some embodiments, CORTAIN TOP COAT utilizes a two part [ONE TO THREE RATIO] highly cross-linked [A side] formula made up of a synthetic urethane/urea co-polymer of between 75 to 80% by volume; Methylene diphenyldiisocyanate of approximately 0.05%; and tolulene at between 19 to 21%.

According to some embodiments, the B side is made up of ethyl acetate.

According to some embodiments, the top coat A side is made up of 70-80% urethane prepolymer (e.g. CAS 52292-18-9); 0.05% methylene diphenyldiisocyanate; and 20-25% toluene CAS 108-88-3. According to some embodiments, the B side is made up of 85-90% aromatic diamine (e.g. CAS 68479-98-1) and 10-15% cyclohexanone.

According to some embodiments, CORTAIN SELF HEALING MICROCAPS are designed to be mixed into the A side of the Top Coat prior to application. They are essentially made up of water and a hydrotreated paraffinic base that makes up the encapsulated properties of the shell.

The active recoating liquid inside the shell is primarily 4,4′ polymeric diphenylmethane diisocyanate, MDI, diphenylmethanediisocyanate, isonmers and homologues. [Roughly 100 to 250 microns in size].

The inclusion of these workable and functional, low cost and effective resealing, recoating aka “self healing” micro-capsules are used as an additive and are intended to be mixed on site by the applicator, within the A side of the Top Coat to give significantly enhanced durability to the final coat.

With the “self-healing” micro-caps in place, if the Top Coating is bumped, hit, or impacted in some manner, the micro-beads break and flow into the “wounded” or “injured” metal area.

The additional, unique and clever feature of the self healing microcaps is they are dyed a vibrant color, in this particular case a vivid “hot” pink.

The primary, but not the exclusive reason, for this feature is to one, act as a highly visual marking or recognition device in order for maintenance personnel to more easily see or identify where a breach in the coating has occurred.

Secondly the microcapsules act in a capillary like action, mimicking nature by “bleeding” and recoating the breached area, thus actually “clotting and drying,” much as a wounded human or animal when injured.

According to some embodiments, the CORTAIN system utilizes a cleansing coat. The cleansing coat may comprise sodium dihydrogen phosphate; sodium gluconate; sodium 3-nitrobenzenesulphonate, and a surfactant.

According to some embodiments, the CORTAIN system utilizes a plurality of zinc flakes dispersed in the primer. Suitable zinc flake is available from Novamet, and has a 90%-325 mesh, an density of 1.7 g/cm3, and a thickness of 1.0 microns.

According to some embodiments, the CORTAIN system utilizes a fixotropic dispersed in the top coat. Suitable fixotropic is Aerosil® 200, available from Evonik.

In summation, The CORTAIN system utilizes a unique nano-coating SAMP primer that not only keeps hydrogen and oxygen molecules separated from the metal surface, but it is uniquely designed to act like “velcro” allowing a 1200 PSI to 1750 PSI adhesion [testing by EXOVA LABS HOUSTON, TEX.] and creating a high adhesion bond between the metal surface and the polymer secondary primer. They were designed specifically and uniquely to bond only to each other and be chemically compatible to each component exclusively. Competitive epoxy coatings have an adhesion rate of approximately 900 to 1000 psi according to AMERON, a major supplier of epoxy coatings to Chevron.

All other nano-coatings presently existing, to our knowledge, act primarily as top coats only, and feature a “lotus effect” non stick coating feature, thus unable to provide durability over a long duration of 30 to 50 years. Also to our knowledge, other nano-coatings do not allow compatibility with other polymer based visco elastic or epoxy or ceramic coatings.

The CORTAIN system utilizes a polymer urea/urethane coating that has 538% elongation allowing it to expand and contract with freeze thaw cycles.

The CORTAIN system utilizes a polymer urea/urethane coating that has exhibited higher acid resistance than ceramics, epoxies, and even other urea/urethane coatings according to independent labs cited.

The CORTAIN system utilizes a polymer urea/urethane coating additive that has a unique self healing and self marking visual identification feature that mimics nature's ability to self heal while marking the site for easier repairs.

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### Example 1

This Example serves to illustrate the corrosion resistance, resistance to strong strong acid, resistance to water, resistance to salt water, and adhesion properties of an exemplary coating.

In a typical procedure, a metal surface was coating with an anti-corrosion coating as described herein. The coating included a cleansing coat, a SAMP nanoprimer, a polyurethane primer comprising zinc flake, and a polyurethane top coat comprising self-healing diisocyanate/paraffin wax microcapsules and fixotropic. Testing was conducted on the coating. Testing according to ASTM-B-117-09, of maintaining salt spray environment yielded results of protection against salt water for at least 3000 hours. Testing according to ASTM-D-3359, for adhesion, yielded results of 1700 PSI. Testing of acid resistance to nitric acid, to 40% hydrofluoric acid, to 35% hydrochloric acid, and to 70% sulfuric acid yielded excellent results. Testing of chemical resistance to 50% Clorox, to ammonia, and to sea water also yielded excellent results.

In conclusion, the present invention provides an economical, non-epoxy-based, corrosion coating having favorable resistance to acid and to salt water, and having favorable adhesion properties.

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. An anti-corrosion coating for a metal surface, comprising:
a nanoprimer comprising a self-assembled phosphonate monolayer disposed over the metal surface;
a polyurethane primer disposed over the nanoprimer;
a polyurethane top coat disposed over the polyurethane top coat comprising microcapsules adapted for self-healing, wherein the polyurethane top coat adheres to the polymeric primer; and
microcapsules adapted for self-healing, wherein the microcapsules are dispersed in the polyurethane top coat.

2. The anti-corrosion coating according to claim 1, wherein the microcapsules comprise a diisocyanate core and a paraffin wax shell.

3. The anti-corrosion coating according to claim 1, wherein the polyurethane primer further comprises a plurality of zinc flakes.

4. The anti-corrosion coating according to claim 1, wherein the nanoprimer adheres to the metal surface.

5. The anti-corrosion coating according to claim 1, further comprises a cleansing coat.

6. The anti-corrosion coating according to claim 5, wherein the nanoprimer adheres to the cleansing coat.

7. The anti-corrosion coating according to claim 1, wherein the polyurethane top coat further comprises a fixotropic.

8. The anti-corrosion coating according to claim 1, wherein the polyurethane top coat is derived from reaction of a top coat resin component A and a top coat curative component B.

9. The anti-corrosion coating according to claim 8, wherein the top coat curative component B comprises a solvent comprising cyclohexanone.

10. The anti-corrosion coating according to claim 9, wherein the cyclohexanone solvent promotes adherence of the polyurethane top coat to the polyurethane primer.

11. The anti-corrosion coating according to claim 1, further comprising:
a cleansing coat disposed over the metal surface and under the nanoprimer;
zinc flakes dispersed in the polyurethane primer,
wherein the microcapsules comprise a diisocyanate core and a paraffin wax shell;
and wherein the polymeric top coat comprises a fixotropic.

12. An anti-corrosion system, comprising:
a cleansing coat solution;
a nanoprimer solution comprising phosphonate;
a polyurethane primer resin solution;
a polyurethane primer curative solution;
a polyurethane top coat resin solution;
a polyurethane top coat curative solution; and
self-healing microcapsules each comprising a diisocyanate core and a paraffin wax shell.

13. The anti-corrosion system according to claim 12, further comprising seven containers, one for each solution.

14. The anti-corrosion system according to claim 12, further comprising:
a plurality of zinc flakes.

15. The anti-corrosion system according to claim 12, further comprising a fixotropic solution.

16. A method for protective a metal surface, comprising:
disposing a nanoprimer comprising a self-assembled phosphonate monolayer over the metal surface;
disposing a polyurethane primer over the nanoprimer; and
disposing a polyurethane top coat over the polyurethane primer, wherein the polyurethane top coat comprises microcapsules adapted for self-healing.

17. The method according to claim 16, wherein the microcapsules each comprising a diisocyanate core and a paraffin wax shell.

18. The method according to claim 16, wherein disposing the polyurethane top coat comprises:
dispersing a plurality of microcapsules adapted for self-healing in a polyurethane top coat resin;
mixing the polyurethane top coat resin with a polyurethane top coat curative; and
applying the mixture to the polymeric primer.

19. The method according to claim 18, wherein the polyurethane top coat curative solution comprises a cyclohexanone solvent.

20. The method according to claim 16, further comprising dispersing zinc flakes in the polyurethane primer.
